(19) United States
(12) Patent Application Publication
(10) Pub. No.: US 2026/0264469 A1
(43) Pub. Date: Sep. 10, 2026

(54) SENSOR DEVICE AND DAMPING FORCE ADJUSTABLE SUSPENSION SYSTEM

(71) Applicant: Astemo, Ltd., Tokyo (JP)

(72) Inventor: Junya NAKAMURA, Hitachinaka-shi (JP)

(73) Assignee: Astemo, Ltd., Tokyo (JP)

(21) Appl. No.: 19/164,935

(22) PCT Filed: Mar. 13, 2023
(86) PCT No.: PCT/JP2023/009508

§ 371 Date: Sep. 12, 2025

(51) Int. Cl. B60G 17/019; B60G 17/0165; B60G 17/08; G01D 5/20

(52) U.S. Cl. CPC B60G 17/019; B60G 17/0165; B60G 17/08; G01D 5/202; B60G 2202/24; B60G 2204/112; B60G 2204/62; B60G 2206/41; B60G 2300/12; B60G 2400/204; B60G 2400/252; B60G 2400/7162; B60G 2400/90; B60G 2500/104; B60G 2600/182; B60G 2800/162; B60G 2800/916; G01D 2205/18

(57) ABSTRACT

A sensor device includes: an LC oscillation circuit including a coil in which an inductance changes according to a displacement amount of an object and a DC resistor changes according to a temperature, and an oscillation unit including an LC resonance capacitor electrically connected to the coil; and a switching unit including a switch that switches whether to electrically connect one end of the coil to a predetermined DC potential, when the switch is off, the LC oscillation circuit is in a first state in which an AC signal whose frequency changes according to the displacement amount of the object is output, and when the switch is on, the LC oscillation circuit stops oscillation and is in a second state in which a DC voltage whose voltage value changes according to the temperature of the coil is output from a common connection point.

### CROSS-REFERENCE TO RELATED PATENT APPLICATIONS

This application is a U.S. National Phase Application under 35 U.S.C. § 371 of International Patent Application No. PCT/JP2023/009508 filed on Mar. 13, 2023, the content of which is incorporated herein by reference in its entirety. The International Patent Application was published in Japanese on Sep. 19, 2024 as International Publication No. WO/2024/189718 under PCT Article 21(2).

### FIELD OF THE INVENTION

The present invention relates to a sensor device, a damping force adjustable suspension system, and the like.

### BACKGROUND OF THE INVENTION

Paragraph [0041] and FIG. 2 of JP6663086B show an LC oscillation circuit constituting a stroke sensor.

Paragraph [0019] and FIGS. 1 and 2 of JP6983619B show a configuration in which in a front suspension of a motorcycle, a solenoid valve as a damping force adjustable unit is integrally attached to the suspension.

Paragraph [0045] and FIG. 3 of JP6625791B show a configuration in which, in a stroke sensor using an LC oscillation circuit, a coil and a capacitor are disposed inside a tubular body, and when a temperature inside the tubular body rises, inductance of the coil increases, but capacitance of the capacitor decreases, and thus a fluctuation of a resonance frequency due to the temperature is suppressed.

Paragraphs [0017], [0018], and FIGS. 3 and 4 of JP2004-316848A show that a resistance value of a coil increases with temperature and a temperature of hydraulic oil is estimated based on a voltage value applied to the coil and a current value flowing through the coil.

### PRIOR ART

### Patent Literatures

Patent Literature 1: JP6663086B
Patent Literature 2: JP6983619B
Patent Literature 3: JP6625791B
Patent Literature 4: JP2004-316848A

### Problem to be Solved by the Invention

Studies by the present inventors have revealed the following problem. That is, when a temperature of a fluid in the suspension accommodating the fluid rises due to the operation of the suspension, damping force characteristics of the suspension change.

For example, although the temperature of the fluid is a standard temperature at the beginning of operation of the vehicle, if the temperature rises with the passage of time, even if an appropriate damping force is initially generated, the damping force may deviate from an appropriate range after the temperature rise.

In this case, for example, by adjusting resistance of the fluid using the damping force adjustable unit having a solenoid attached to the suspension, in other words, the solenoid valve, it is possible to correct the damping force according to a change in temperature.

However, in this case, the temperature of the fluid needs to be measured by a temperature sensor. However, in recent years, along with the size reduction of the suspension, it may be difficult to ensure a space for newly installing the temperature sensor in the suspension accommodating the fluid.

JP6663086B merely shows an example of the LC oscillation circuit constituting the stroke sensor. There is no description of the necessity of correction of the damping force in the damping force adjustable unit accompanying the temperature rise of the fluid, the relation between the correction of the damping force and the LC oscillation circuit, and the like.

JP6983619B does not describe the necessity of correction of the damping force in the damping force adjustable unit accompanying the temperature rise of the fluid.

In JP6625791B, in the stroke sensor using the LC oscillation circuit, the coil and the capacitor are installed in the same temperature environment, and a measurement error of displacement is suppressed using the fact that the characteristics of elements are different from each other. However, the technique of JP6983619B cannot provide a solution to a fluctuation of the damping force due to the temperature change.

In JP2004-316848A, the temperature of the hydraulic oil is estimated based on the voltage value applied to the coil and the current value flowing through the coil. In JP6625791B, in order to estimate the temperature of the hydraulic oil, it is necessary to newly prepare a reference voltage source whose applied voltage is adjustable, a current source, or the like, and this undeniably increases the burden on the circuit.

An object of the present invention is to provide a sensor device capable of measuring, a temperature of, for example, a fluid without newly adding a temperature sensor.

Another object of the present invention is to provide a damping force adjustable suspension system capable of correcting a damping force according to a temperature.

### SUMMARY OF THE INVENTION

### Means for Solving the Problem

As a result of intensive studies, the present inventors have found that the above problem can be solved by stopping oscillation of an LC oscillation circuit and forming a resistance voltage dividing circuit with a predetermined resistor of an oscillation unit and a DC resistor of a coil in the LC oscillation circuit.

The present invention was completed based on these findings.

Hereinafter, the present disclosure will be described.

According to a first aspect of the present disclosure, there is provided a sensor device (SE) including: an LC oscillation circuit (150) including a coil (108) in which an inductance changes according to a displacement amount of an object (200) and a DC resistor changes according to a temperature, and an oscillation unit (132) including an LC resonance capacitor (134) electrically connected to the coil; and a switching unit (138) including a switch (SW) that switches whether to electrically connect one end (N20) of the coil to a predetermined DC potential, in which when the switch is off, the LC oscillation circuit is in a first state in which an AC signal (Iout) whose frequency changes according to the displacement amount of the object is output, and when the switch is on, the LC oscillation circuit stops oscillation and is in a second state in which a DC voltage (Vtemp) whose voltage value changes according to the temperature of the coil is output from a common connection point (N1) between a predetermined resistor (R24) that is a component of the oscillation unit and the other end (N30) of the coil (108).

Here, the temperature of the coil reflects a temperature of a fluid around the coil, for example, a hydraulic oil. Therefore, it can be said that the DC voltage (Vtemp) is a voltage whose voltage value substantially changes according to the temperature of the fluid, and thus the temperature of the fluid can be measured.

The DC voltage (Vtemp) whose voltage value changes according to the temperature of the coil may be a DC voltage directly obtained from the common connection point (N1) between the predetermined resistor (R24) and the other end (N30) of the coil (108), or may be a DC voltage obtained by amplifying the DC voltage by an amplification circuit (139).

According to another aspect of the present disclosure, there is provided a damping force adjustable suspension system (400) including: a suspension (19) including a tubular first member (100) and a tubular second member (200) provided to be movable relative to the first member in an axial direction of the first member, and configured to accommodate a fluid therein; an electronically controlled damping force adjustable unit (130) having a solenoid (133), configured to variably control a resistance of the fluid moving according to a relative positional relation between the first member and the second member by a drive current or a drive voltage of the solenoid, and integrally attached to the suspension; the sensor device (SE) according to any one of the first to sixth aspects disposed in the suspension and configured to use either the first member or the second member as the object; and a suspension control unit (300) having a function of controlling on/off of the switch in the switching unit and a function of controlling the electronically controlled damping force adjustable unit, in which the suspension control unit (300) is provided in the suspension (19) or integrally attached to the suspension (19).

### Effects of Invention

According to the present invention, by switching an operation state of the sensor device by turning on/off the switch of the switching unit, it is possible to implement both the stroke sensor that detects displacement of the object and the temperature sensor that measures the temperature of the coil without adding a new configuration.

Further, according to the present invention, it is possible to correct temperature-dependent damping force characteristics, which has been difficult in the related art, by aggregating the suspension control unit (control board) on the suspension to realize commonality of a temperature environment by the design of mechanical and electrical integration, and by utilizing the sensor device serving as both the stroke sensor and the temperature sensor.

### BRIEF DESCRIPTION OF THE DRAWINGS

FIG. 1 is a side view of an example of a motorcycle to which a front suspension and a rear suspension are attached.

FIG. 2 is a diagram showing an example of a configuration of a damping force adjustable suspension system.

FIG. 3 is a diagram showing another example of the configuration of the damping force adjustable suspension system.

FIG. 4 is a diagram showing still another example of the configuration of the damping force adjustable suspension system.

FIG. 5 is a diagram showing an example of a circuit configuration of a sensor device.

FIG. 6 is a diagram in which (A) and (B) show circuit configuration examples of a DC bias voltage generation circuit.

FIG. 7 is a diagram showing a configuration example of a switching unit including a switch.

FIG. 8 is a diagram showing an example of a detection output of a stroke sensor implemented when the switch of the switching unit is off.

FIG. 9 is a diagram showing an example of an operation of a temperature sensor, a detection output of the temperature sensor, and characteristics with respect to a temperature as the detection output, which are implemented when the switch of the switching unit is on.

FIG. 10 is a diagram showing an effect of calibrating a solenoid drive current based on a detected temperature.

FIG. 11 is a flowchart showing an example of a control procedure of the damping force adjustable suspension system by the suspension control unit.

### DETAILED DESCRIPTION OF THE INVENTION

Embodiments of the present invention will be described below with reference to the accompanying drawings. The embodiments shown in the accompanying drawings are examples of the present invention, and the present invention is not limited to the embodiments.

### Embodiment 1

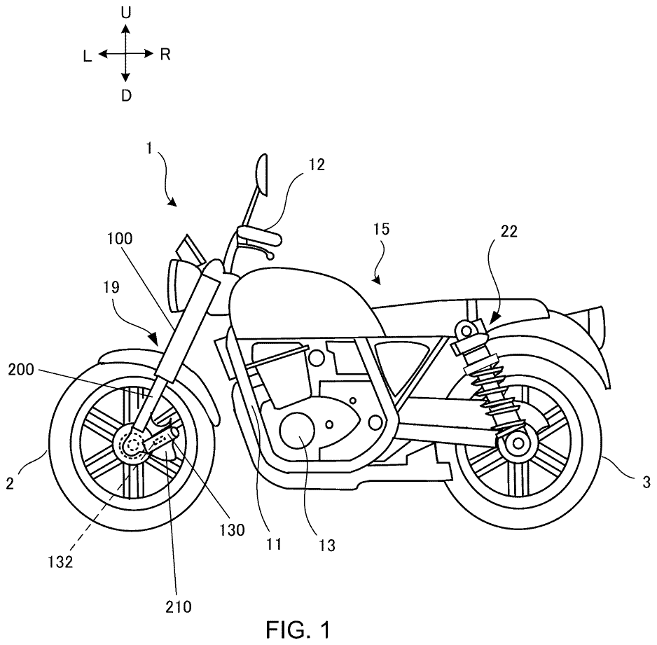

Reference is made to FIG. 1. FIG. 1 is a side view of an example of a motorcycle to which a front suspension and a rear suspension are attached.

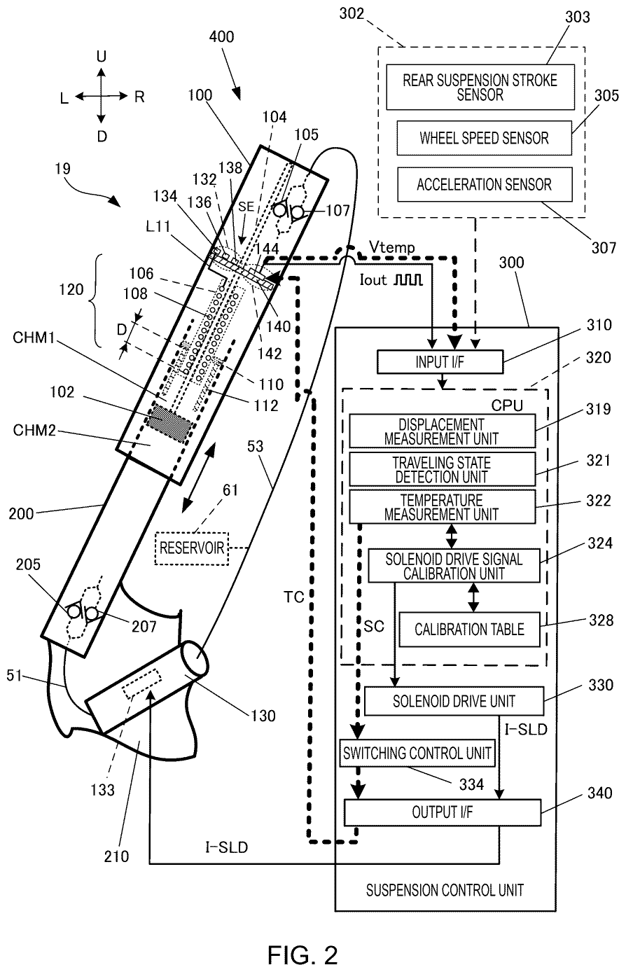

Reference signs L, R, U, and D shown in an upper part of FIG. 1 denote left, right, upper, and lower, respectively. This point also applies to FIGS. 2 to 4.

In FIG. 1, a motorcycle 1 includes a front wheel 2 that is a wheel in a front side, a rear wheel 3 that is a wheel in a rear side, and a vehicle main body 15 including a vehicle body frame 11, a handlebar 12, an engine 13, and the like that constitute a framework of the motorcycle 1.

The motorcycle 1 includes one front fork 19 as the front suspension that connects the front wheel 2 and the vehicle main body 15 to each other, on each of a left side and a right side of the front wheel 2. Further, the motorcycle 1 includes one rear suspension 22 connecting the rear wheel 3 to the vehicle main body 15 on each of a left side and a right side of the rear wheel 3. In FIG. 1, only the front fork 19 and the rear suspension 22 disposed on the left side are shown.

The front fork 19 includes an outer tube 100 disposed at an upper portion and having an upper end closed by a lid body (not shown), an inner tube 200 extending downward from the inside of the outer tube 100 and provided to be movable relative to the outer tube 100, a suspension arm 210 provided at a lower end of the inner tube 200, and an electronically controlled solenoid valve 130 as a damping force adjustable unit provided to be integrally incorporated in the suspension arm 210 and incorporating a solenoid 133.

The outer tube 100 is a tubular member whose upper portion is supported by the vehicle main body 15. A part of an upper side of the inner tube 200 is inserted into the outer tube 100, is movable relative to the outer tube 100, and is biased in a direction away from the outer tube 100 by a spring (not shown).

The outer tube 100 and the inner tube 200 are components of the front fork 19 as the front suspension, and the outer tube 100 and the inner tube 200 constitute an accommodation container in which hydraulic oil as a working fluid is accommodated. The working fluid may be a liquid or a gas such as air.

When the outer tube 100 is referred to as a first member and the inner tube is referred to as a second member, the front fork 19 is a suspension that includes the tubular first member 100 and the tubular second member 200 provided to be movable relative to the first member 100 in an axial direction of the first member 100, and that accommodates a fluid therein.

Further, the solenoid valve 130 includes the solenoid 133, and can be referred to as the electronically controlled damping force adjustable unit that can variably control resistance of the fluid, that is, the hydraulic oil, that moves according to a relative positional relation between the first member 100 and the second member 200 by a drive current or a drive voltage of the solenoid 133, and is integrally attached to the suspension 19.

The suspension 19 is a mechanism that absorbs impact in a broad sense, and specifically includes a shock absorber and a spring (not shown). A damping force of the shock absorber is generated by a resistance force when the working fluid passes through a narrow flow path in response to the motion of the piston (not shown in FIG. 1).

In the above description, the “resistance of the fluid, that is, the hydraulic oil, that moves” is described, but this can be referred to as a resistance force when the hydraulic oil as the working fluid flows through the flow path.

When the solenoid drive current flows through the solenoid 133 incorporated in the solenoid valve 130, an action of an electromagnet occurs, and for example, a movable iron core (not shown) or the like moves in a predetermined direction. Thereby, the resistance when the fluid flows through the flow path, that is, the resistance force can be adjusted.

Therefore, when the solenoid valve 130 is used, the damping force can be variably controlled by electronic control. The above configuration is an example, and valves having various configurations can be used as the electronically controlled damping force adjustable unit.

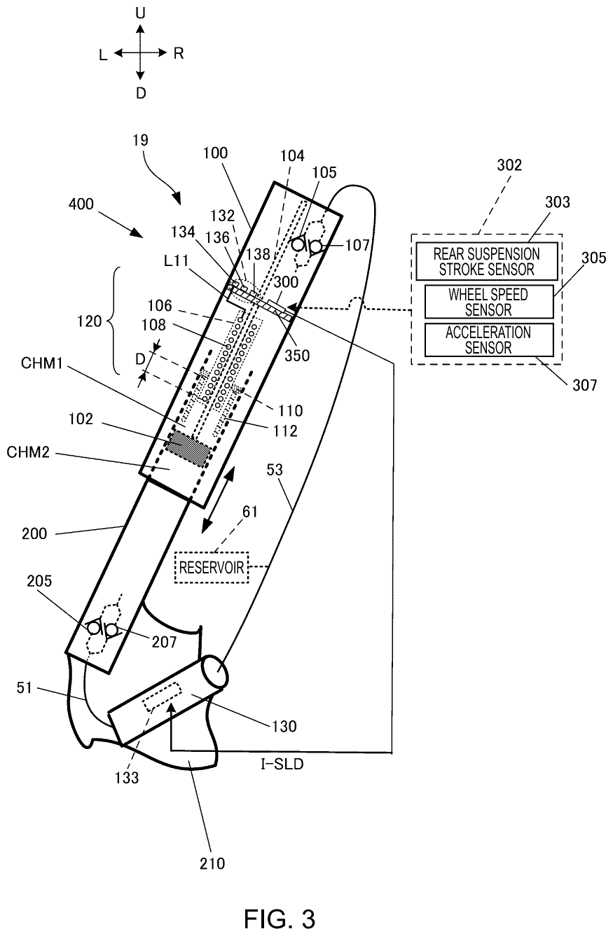

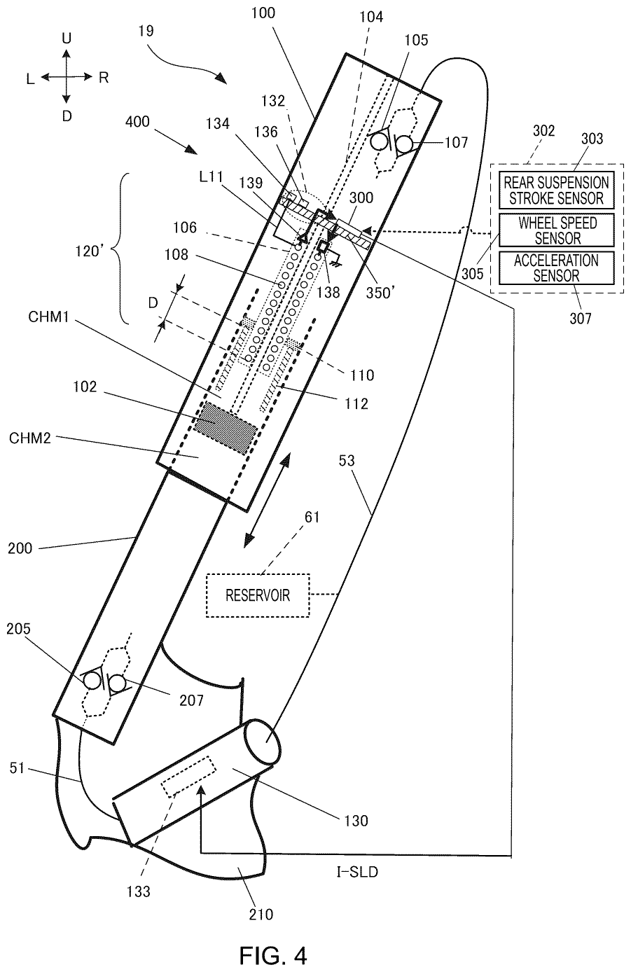

Next, FIG. 2 will be referred to. FIG. 2 is a diagram showing an example of a configuration of a damping force adjustable suspension system. In FIG. 2, the same components as those in FIG. 1 are denoted by the same reference numerals. This point also applies to FIGS. 3 and 4.

As described above, the inner tube 200 is biased by the spring in a direction away from the outer tube 100, but in FIG. 2, the spring is not shown in order to avoid complication of the drawing. This point also applies to FIGS. 3 and 4.

First, a configuration related to a stroke sensor 120 will be described.

A coil member 106 including a piston 102, a rod 104, and a coil 108 is provided in the outer tube 100 of the front fork 19.

The coil member 106 is, for example, one electric component in which the coil 108 made of copper is covered with an electrical insulating material. The coil member 106 may be referred to as a coil component.

The piston 102 is supported by a rod 104, the coil member 106 is integrated with the rod 104, and the rod 104 is fixed to the outer tube 100 by a mechanical structure (not shown). That is, the piston 102, the rod 104, and the coil member 106 are integrated with, in other words, fixed to the outer tube 100.

On the other hand, a rod guide 110 for guiding the rod 104 and a conductor tube 112 made of metal are provided inside a portion of the inner tube 200 inserted into the outer tube 100. The conductor tube 112 is a conductor member in a broad sense, and may have a plate shape or a rod shape.

The rod guide 110 is fixed to the inner tube 200, and the conductor tube 112 is fixed to the rod guide 110. Thus, the conductor tube 112 is integrated with the inner tube 200, and when the inner tube 200 moves, the conductor tube 112 is displaced accordingly.

The outer tube 100 and the inner tube 200 are movable relative to each other, and here, the inner tube 200 is described as moving relative to the outer tube 100.

In FIG. 2, the coil 108 and the conductor tube 112 are fitted to each other by a fitting length D along the axial direction of the tubular inner tube 200. When the inner tube 200 moves upward, the conductor tube 112 also moves upward, so that the fitting length D increases.

On the other hand, when the inner tube 200 moves downward, the conductor tube 112 also moves downward, so that the fitting length D decreases.

An oscillation circuit (not shown in FIG. 2) is electrically connected to the coil 108. When the fitting length D increases or decreases, the power consumed by an eddy current generated in the conductor tube 112 changes, an inductance of the coil 108 substantially changes, and an oscillation frequency of the oscillation circuit, in other words, a resonance frequency fluctuates.

The stroke sensor 120 can detect a displacement amount of the inner tube 200 as a measurement object by detecting a change in the frequency. The measurement object may be the outer tube 100.

Here, when the relative positional relation between the inner tube 200 and the outer tube 100 changes, the position of the piston 102 moves by the amount of change, and thus the movement of the hydraulic oil as the fluid occurs.

As shown in FIG. 2, the inside of the inner tube 200 is segmented into a first oil chamber CHM1 and a second oil chamber CHM2 by the piston 102.

As the flow path of the hydraulic oil, a first flow path that flows from the second oil chamber CHM2 to the first oil chamber CHM1 via a check valve 205, a pipe 51, the solenoid valve 130 as the damping force adjustable unit, a tube 53, and a check valve 105, and a second flow path that flows from the first oil chamber CHM1 to the second oil chamber CHM2 via a check valve 107, the tube 53, the solenoid valve 130 as the damping force adjustable unit, the pipe 51, and a check valve 207 are provided. A reservoir 61 may be connected to the tube 53.

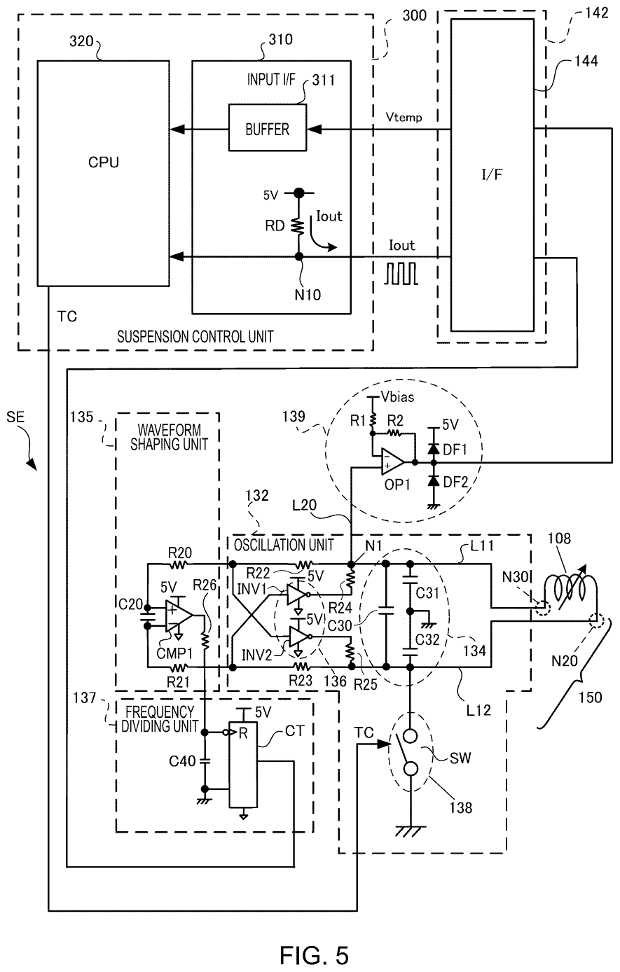

In the outer tube 100, a control board 140 is fixedly provided at a predetermined position. A circuit including an LC oscillation circuit and the like as shown in FIG. 5 described later is formed on the control board 140. A detailed circuit configuration and operation will be described with reference to FIG. 5.

In FIG. 2, an oscillation unit 132 of the LC oscillation circuit is provided on a left side of the control board 140, and an interface unit 142 is provided on a right side thereof.

The oscillation unit 132 is provided with a resonance capacitor 134 used for LC oscillation, an inverter 136 as a drive circuit that drives the coil 108, and a switching unit 138 that switches the LC oscillation circuit between an operation state as a stroke sensor and an operation state as a temperature sensor.

The coil 108 and the capacitor 134 are electrically connected by a wiring L11.

The interface unit 142 is provided with an interface circuit 144.

The oscillation unit 132, the interface unit 142, and the like mounted on the control board 140 constitute a sensor device SE. Details of the sensor device SE will be described later with reference to FIG. 5.

Next, a suspension control unit 300 will be described.

The suspension control unit 300 controls an operation of the front fork 19 as the front suspension, and can be implemented as, for example, an electronic control unit (ECU) for the suspension.

The suspension 19 and the suspension control unit 300 shown in FIG. 2 constitute a damping force adjustable suspension system 400.

For example, various types of information that change according to a driving state of the vehicle are input to the suspension control unit 300 from various sensors 302. Examples of the various sensors 302 include a rear suspension stroke sensor 303, a wheel speed sensor 305, and an acceleration sensor 307.

The suspension control unit 300 includes an input interface (I/F) 310, a central processing unit (CPU) 320 as a processor, a solenoid drive unit 330, a switching control unit 334 that controls on/off of a switch in the switching unit 138, and an output interface (I/F) 340. The “CPU” may also be referred to as a “control unit”.

The CPU 320 includes a displacement measurement unit 319 that detects displacement of the inner tube 200 as an object, that is, a change in the fitting length D, based on the frequency of an AC signal Iout as a current signal output from the stroke sensor 120, a traveling state detection unit 321, a temperature measurement unit 322, a solenoid drive signal calibration unit 324, and a calibration table 328.

The “solenoid drive signal calibration unit” may be simply referred to as a “calibration unit”.

The traveling state detection unit 321 detects a traveling state of the vehicle on which the damping force adjustable suspension system is mounted.

In a preferred example, the traveling state detection unit 321 detects a traveling state of a vehicle 1 based on detection signals of the rear suspension stroke sensor 303, the wheel speed sensor 305, and the acceleration sensor 307.

For example, the temperature measurement unit 322 determines whether the vehicle 1 is in a state suitable for temperature measurement, in other words, whether the vehicle 1 is in a traveling period suitable for the temperature measurement, based on a detection result of the traveling state detection unit 321.

For example, when the vehicle 1 is stopped or when the vehicle 1 is in a stable traveling state with little change in behavior, it may be determined that the vehicle 1 is in the state suitable for the temperature measurement.

Specifically, the behavior of the vehicle may include behavior such as vehicle speed fluctuations and lateral swaying when the vehicle is traveling linearly, or rotation behavior indicating that the vehicle is rotating (turning).

For example, when the vehicle is turning around a curve of a traveling road, a traveling direction is constantly changing, the vehicle speed may also change drastically, and thus it is considered that the vehicle does not correspond to the state suitable for the temperature measurement in many cases.

When the vehicle is traveling linearly at a constant speed or when the vehicle is traveling linearly at a speed equal to or lower than a reference speed, it may be determined that the vehicle is in the state suitable for the temperature measurement.

When the vehicle stops traveling, for example, when the vehicle is temporarily stopped while continuing to travel, there is no particular problem even if the detection signal of the stroke sensor may not be obtained.

When the vehicle is traveling stably, preferably linearly, the suspension is considered to repeat compression and expansion at a constant cycle. Therefore, even if the detection signal of the stroke sensor may not be obtained for a while, it is considered that there will be no particular problem during that period by, for example, maintaining the cycle detected immediately before and adjusting the damping force.

When the temperature measurement unit 322 determines to start the temperature measurement, the temperature measurement unit 322 sends a temperature measurement start notification signal SC to the switching control unit 334.

The switching control unit 334 that has received the notification signal SC transmits the switching control signal TC to the switching unit 138 in the sensor device SE. In other words, the switching control unit 334 performs switching control to turn on the switch of the switching unit 138. Accordingly, the temperature measurement is started.

That is, by this switching control, the LC oscillation circuit of the sensor device SE temporarily stops oscillation, the AC signal (oscillation signal) Iout is stopped, and instead, a DC voltage Vtemp as a temperature detection signal whose voltage value changes depending on a temperature of the coil 108 is output from the sensor device SE.

The temperature measurement unit 322 measures the temperature of the coil 108 based on the DC voltage Vtemp.

The solenoid drive signal calibration unit (calibration unit) 324 changes a drive current value or a drive voltage value of the solenoid 133 according to the temperature measurement result.

For example, the drive current value or the drive voltage value of the solenoid of the coil 108 made of copper at a standard temperature of 20° C. is stored in the solenoid drive signal calibration unit 324 as a standard value.

The calibration table 328 stores a correction value of the solenoid drive current or the drive voltage corresponding to the temperature of the coil. The calibration table 328 includes, for example, a nonvolatile memory.

A suspension manufacturer measures, for example, damping force characteristics in a state in which an environmental temperature is a normal temperature (standard temperature) and damping force characteristics in a state in which the environmental temperature is a high temperature before shipment of a product. Then, even in the high-temperature state, in order to realize the damping force characteristics that are substantially the same as the ideal damping force characteristics of the solenoid at the standard temperature, a correction value for each temperature is acquired, and the correction value is stored in the calibration table 328, for example, in a map format.

The calibration unit 324 acquires the correction value corresponding to the measured temperature with reference to the calibration table 328, and calculates a current value and a voltage value of the solenoid drive signal based on the correction value.

The calculated current value and voltage value of the solenoid drive signal are supplied to the solenoid drive unit 330. In the example of FIG. 2, the solenoid drive unit 330 generates a solenoid drive current signal I-SLD based on the calibrated drive current value, and supplies the solenoid drive current signal I-SLD to the solenoid 133 in the solenoid valve 130.

Accordingly, a variation in the damping force based on a temperature difference is corrected, and an appropriate damping force independent of the temperature of the coil 108 can be always generated.

In a state in which the stroke sensor 120 is operating, the AC signal (oscillation signal) Iout as the current signal is output from the stroke sensor 120 while the vehicle 1 is traveling.

When it is necessary to change the damping force, the solenoid drive unit 330 determines an appropriate timing for changing the damping force based on the displacement amount measured by the displacement measurement unit 319, that is, a stroke amount. Then, at the appropriate timing, the drive current value and the drive voltage value of the solenoid 133 are updated as appropriate.

When the displacement measurement unit 319 measures the displacement amount, that is, the stroke amount, the measured stroke amount may be corrected based on a temperature measured most recently. Accordingly, detection accuracy of the stroke amount is improved.

In the example of FIG. 2, the suspension control unit 300 is not mounted inside the suspension 19.

In this case, in order to bring an environmental temperature of the suspension control unit 300 close to an environmental temperature of the coil 108, the solenoid 133, and the control board 140, for example, it is preferable that the control board on which the suspension control unit 300 is mounted is integrally attached to an empty space of the suspension arm 210 of the suspension 19 or integrally attached to an outer surface of a bottom portion of the inner tube 200.

Accordingly, by making the environmental temperatures of the components related to the compensation of the temperature characteristics substantially the same, accuracy of the compensation of the temperature characteristics can be improved.

Next, FIG. 3 will be referred to. FIG. 3 is a diagram showing another example of the configuration of the damping force adjustable suspension system. In FIG. 3, portions common to those in FIG. 2 are denoted by the same reference numerals, and description of the common portions is omitted.

In the example of FIG. 3, the suspension control unit 300 located outside the suspension 19 in FIG. 2 is incorporated into the suspension 19. That is, in FIG. 3, the suspension control unit 300 shown in FIG. 2 is provided in the suspension 19, in other words, in the outer tube 100 as the first member.

In the example of FIG. 3, the control board 140 of FIG. 2 is replaced with a control board 350. The suspension control unit 300 shown in FIG. 2 is mounted on the control board 350. The control board 350 can also be referred to as an ECU board.

Accordingly, the environmental temperature of the suspension control unit 300 can be made closer to the temperature of the coil 108, that is, the temperature of the hydraulic oil as the fluid, and the accuracy of the compensation of the temperature characteristics can be further improved.

Next, FIG. 4 will be referred to. FIG. 4 is a diagram showing still another example of the configuration of the damping force adjustable suspension system. In FIG. 4, portions common to those in FIGS. 2 and 3 are denoted by the same reference numerals, and description of the common portions will be omitted.

In FIG. 3 shown above, the switching unit 138 is mounted on the control board 350, and although not shown in FIG. 3, an amplification unit that amplifies the DC voltage Vtemp obtained at the time of temperature measurement is also mounted on the control board 350.

In FIG. 4, the amplification unit is denoted by reference numeral 139. In the example of FIG. 4, the switching unit 138 and the amplification unit 139 are provided in the coil member 106 as an electric component including the coil 108. In other words, the switching unit 138 and the amplification unit 139 are integrated with the coil member 106.

However, the present disclosure is not limited thereto, and at least one of the switching unit 138 and the amplification unit 139 may be provided in the coil member 106.

In FIG. 4, since the switching unit 138 and the amplification unit 139 are provided in the coil member 106, the switching unit 138 and the amplification unit 139 need not be mounted on a control board 350′ in FIG. 4.

Therefore, for example, even if the size and weight of the suspension 19 are reduced and an area occupied by the circuit on the control board is further reduced, since an installation space for the switching unit or the amplification unit is unnecessary, it is possible to cope with this.

In FIG. 4, since the switching unit 138 can be disposed near one end of the coil 108, when a switch of the switching unit 138 is turned on, one end of the coil 108 can be connected to a predetermined potential, for example, a ground potential with low impedance, and thus it is possible to shorten time required to shift an oscillation circuit in an oscillation state to a state in which the oscillation is stopped.

Further, in FIG. 4, the amplification unit 139 can be disposed near one end of the coil, and thus the DC voltage Vtemp reflecting the temperature of the coil 106 can be amplified in a state in which damping is small or noise is small.

Next, FIG. 5 will be referred to. FIG. 5 is a diagram showing an example of the circuit configuration of the sensor device. In FIG. 5, the same parts as those in the foregoing drawings are denoted by the same reference numerals.

The sensor device SE shown in FIG. 5 includes the oscillation unit 132, a waveform shaping unit 135, a frequency dividing unit 137, the interface unit 142, and the coil 108 constituting an LC oscillation circuit 150. The frequency dividing unit 137 may be omitted.

The LC oscillation circuit 150 constitutes a stroke sensor 120 that detects displacement of an object. Here, the “object” is the inner tube 200 as the second member in FIGS. 2 to 4 shown above, and the “displacement” is the fitting length D between the coil 108 and the conductor tube 112 as the conductor member shown previously in FIG. 2.

The coil 108 is a coil whose inductance changes according to the displacement amount of the object and whose DC resistor changes according to the temperature.

The LC resonance capacitor 134 is electrically connected to the coil 108 to constitute the LC resonance circuit 150.

The oscillation unit 132 includes a capacitor C31 having one end connected to the ground potential and the other end connected to the wiring L11, a capacitor C32 having one end connected to the ground potential and the other end connected to a wiring L12, a capacitor C30 having one end connected to the wiring L11 and the other end connected to the wiring L12, two inverters INV1 and INV2 cross-coupled to form a positive feedback circuit, and resistors R22 to R25. A power supply voltage of each of the inverters INV1 and INV2 is, for example, 5 V.

The capacitors C30 to C32 constitute the resonance capacitor 134 of the LC oscillation circuit 150. The resonance capacitor 134 may be simply referred to as the capacitor 134.

The inverters INV1 and INV2 constitute the inverter circuit 136. Each of the inverters INV1 and INV2 can also be referred to as an inverter element or an amplifier element. Further, the inverter circuit 136 can also be referred to as an amplification circuit for excitation in a state of oscillating an AC signal.

An oscillator constituting the oscillation unit 132 is a Franklin oscillator using an inverter. However, the type of the oscillator is not limited. There is no particular limitation as long as LC oscillation is performed. For example, a Colpitts oscillator may be used.

The oscillation unit 132 is provided with the switching unit 138. The switching unit 138 includes a switch SW that switches whether to electrically connect one end of the coil 108, that is, an end portion of the coil 108 on a wiring L12 side to a predetermined DC potential, here, the ground potential.

In other words, the switch SW can be referred to as a ground fault switch that forcibly causes the one end of the coil 108 to be grounded.

On/off of the switch SW is switched by the switching control signal TC issued by the switching control unit 334 in the suspension control unit 300 shown previously in FIG. 2.

When the switch SW is off, the LC oscillation circuit 150 is in a first state in which an oscillation signal whose frequency changes according to the displacement amount of the object is output.

On the other hand, when the switch SW is on, the LC oscillation circuit 150 stops oscillating, and is in a second state in which a DC voltage whose voltage value changes according to the temperature of the coil 108, in other words, a temperature of a hydraulic oil as a fluid is output from a common connection point N1 between a predetermined resistor that is a component of the oscillation unit 132, that is, the resistor R24 and the other end of the coil 108, that is, an end of the coil 108 on a wiring L11 side.

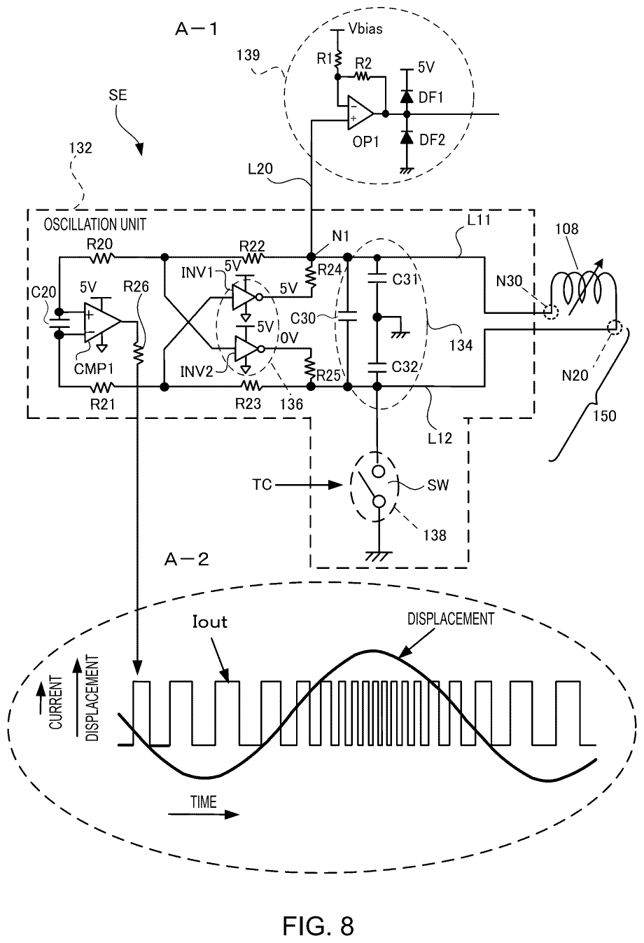

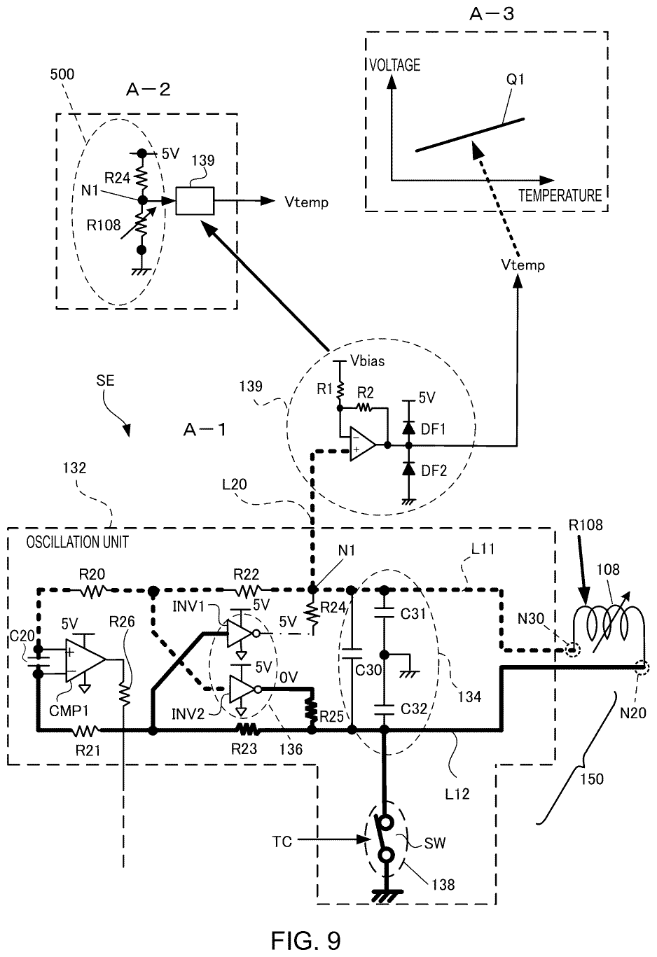

A circuit operation when the switch SW is turned on and a circuit operation when the switch SW is turned off will be described later with reference to FIGS. 8 and 9.

In FIG. 5, the waveform shaping unit 104 includes an input capacitor C20, a comparator CMP1, resistors R20 and R21, and a resistor R26. The resistor R26 is a resistor connected to an output terminal of the comparator CMP1. The comparator CMP1 operates at a power supply voltage of 5 V. An output signal of the comparator CMP1 is a waveform-shaped voltage pulse signal having steep rising and falling edges.

The frequency dividing unit 106 includes a capacitor C40 and a counter (for example, a binary counter) CT. The capacitor C40 functions as an input holding capacitor. The frequency dividing unit 106 may be omitted.

Further, in the sensor device SE shown in FIG. 5, there is provided the amplification unit 139 amplifying a DC voltage that is output from the common connection point N1 between the predetermined resistor R24 and the other end of the coil 108 and whose voltage value changes according to the temperature of the coil 108. The amplification unit may be omitted.

The amplification unit 139 includes a non-inverting operational amplifier OP1 with an offset including resistors R1 and R2, and a voltage limiter including diodes DF1 and DF2 connected in series between a power supply potential of 5 V and the ground potential.

A DC bias voltage Vbias is applied to an inverting terminal of the operational amplifier OP1 via the resistor R1. When an input voltage of the operational amplifier OP1 (the voltage input to a non-inverting terminal of the operational amplifier OP1 via a wiring L20) is Vin and an output voltage is Vout, Vout is expressed by the following equation.

Vout=Vin·(R1+R2)/R1+Vbias

Here, Vbias functions as an offset voltage for adjusting a DC voltage level of the output voltage Vout.

However, when the offset is unnecessary, the DC bias voltage Vbias may be set to 0, that is, Vbias may be set to the ground potential.

By amplifying the DC voltage Vtemp by the operational amplifier OP1, the determination of the voltage value in the suspension control unit 300 is facilitated, and a decrease in determination accuracy due to noise can be suppressed.

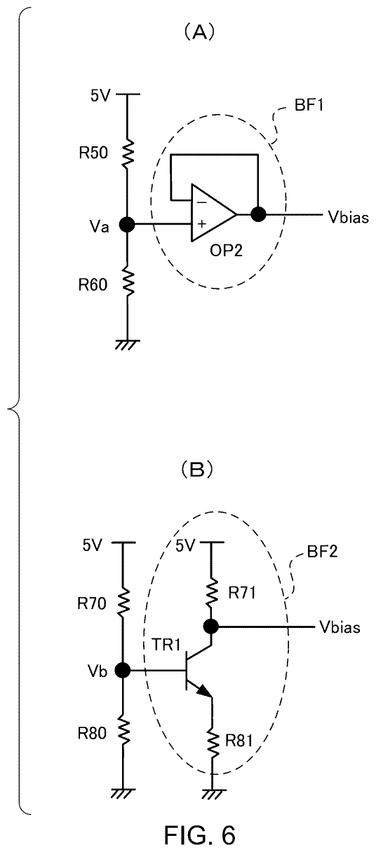

A configuration example of a DC bias voltage generation circuit that generates the DC bias voltage Vbias will be described later with reference to FIG. 6.

The interface unit 142 includes the interface circuit 144. The interface circuit 144 has a function of converting the waveform-shaped voltage pulse signal into an AC signal that is a current signal.

Detection signals of the sensor device SE, that is, the AC signal Iout as the current signal and a DC voltage signal Vtemp are obtained from the interface unit 144. These detection signals are input to the suspension control unit 300.

As shown previously in FIG. 2, the suspension control unit 300 includes the input interface circuit 310 and the central processing unit (CPU) 320 as a processor.

The input interface circuit 310 includes a buffer 311 to which the DC voltage signal Vtemp is input, and a current-voltage conversion resistor RD that converts the AC signal Iout as the current signal into a voltage signal. When the AC current signal Iout flows through the resistor RD, a voltage drop corresponding to the current signal Iout occurs in the resistor RD, and as a result, the converted voltage signal is obtained from an end point N10 of the resistor RD opposite to an end point connected to 5 V.

Next, FIG. 6 will be referred to. (A) and (B) of FIG. 6 are diagrams showing the circuit configuration examples of the DC bias voltage generation circuit.

In (A) of FIG. 6, a divided voltage Va obtained by dividing the power supply voltage 5 V by resistors R50 and R60 is subjected to impedance conversion by a buffer circuit BF1 and output to obtain the DC bias voltage Vbias.

The buffer circuit BF1 includes a voltage follower using an operational amplifier OP2.

In (B) of FIG. 6, the power supply voltage of 5 V is divided by resistors R70 and R80 to generate a divided voltage Vb, and the divided voltage Vb is applied to a base of an emitter-grounded NPN bipolar transistor (hereinafter, simply referred to as a transistor) Tr1. A load resistor R71 is connected to a collector of the transistor TR1, and an emitter resistor R81 is connected to an emitter.

The DC bias voltage Vbias is output from a common connection point between the collector of the transistor TR1 and the load resistor R71.

The transistor TR1, the load resistor R71, and the emitter R81 constitute a buffer circuit BF2.

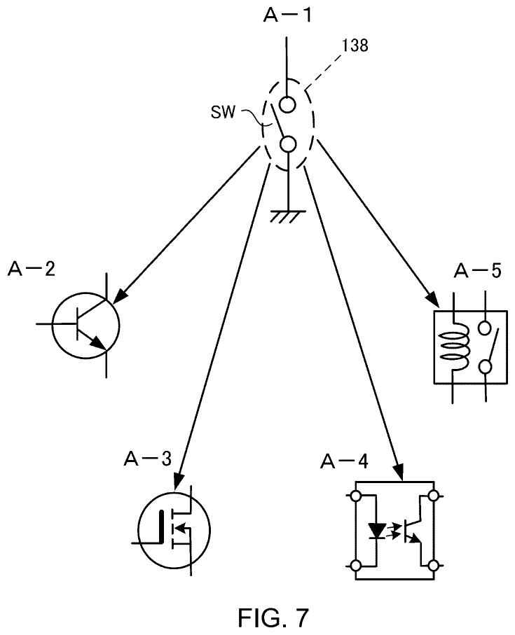

Next, FIG. 7 will be referenced. FIG. 7 is a diagram showing a configuration example of the switching unit including the switch. The switching unit 138 shown in A-1 of FIG. 7 includes the switch SW having one end connected to the ground potential.

The switch SW may be implemented by a bipolar transistor as shown in A-2 of FIG. 7, a field-effect transistor (FET) as shown in A-3 of FIG. 7, a photocoupler as shown in A-4 of FIG. 7, or a relay as shown in A-5 of FIG. 7. Further, the switch elements shown in A-2 to A-5 may be appropriately combined.

That is, the switching unit 138 may include the switch SW that electrically connects the other end of the coil 108 to the predetermined DC potential, that is, the ground potential, and the switch SW may be implemented by at least one selected from the bipolar transistor, the field-effect transistor (FET), the photocoupler, and the relay.

The switching unit 138 can be implemented by one switch element, and an occupied area when mounted on a circuit board can be reduced. Therefore, for example, even if the size and weight of the front fork 19 as the front suspension are reduced and diameters of the tubular outer tube 100 and the tubular inner tube 200 as the first and second members are further reduced, the switching unit 138 can be mounted inside the suspension 19.

That is, the switching unit 138 has a simple configuration and a small size, and thus can be easily mounted on the control boards (circuit boards) 140, 350, and 350′ shown previously in FIGS. 2 to 4.

Next, FIG. 8 will be referred to. FIG. 8 is a diagram showing an example of a detection output of the stroke sensor implemented when the switch of the switching unit is off.

A-1 of FIG. 8 shows a configuration of a main part of the sensor device SE including the oscillation unit 132. This configuration is the same as that previously shown in FIG. 5.

In A-1 of FIG. 8, the switch SW of the switching unit 138 is turned off. Therefore, the sensor device SE operates as the stroke sensor that detects the displacement of the object.

As a result, as shown in A-2 of FIG. 8, the oscillation signal (AC signal) Iout as the current signal whose frequency changes according to the displacement of the object is output from the sensor device SE.

Next, FIG. 9 will be referred to. FIG. 9 is a diagram showing an example of the operation of the temperature sensor, the detection output of the temperature sensor, and characteristics with respect to the temperature as the detection output, which are implemented when the switch of the switching unit is on.

A-1 of FIG. 9 shows a configuration of the main part of the sensor device SE including the oscillation unit 132. This configuration is the same as that previously shown in FIG. 5.

In A-1 of FIG. 9, the switch SW of the switching unit 138 is turned on. Therefore, the sensor device SE operates as the temperature sensor that detects the temperature of the coil, that is, the temperature of the hydraulic oil as the fluid.

In A-1 of FIG. 9, in order to clarify a potential of a wiring in the circuit constituting the oscillation unit 132, the wiring of the ground potential is indicated by a thick solid line, the wiring of the power supply potential of 5 V is indicated by a one-dot chain line, and the wiring of the divided potential by a resistance voltage dividing circuit is indicated by a thick broken line.

As previously described with reference to FIG. 5, the oscillation unit 132 of the LC oscillation circuit 150 includes the inverter circuit 136 that excites the coil 108, and the inverter circuit 136 includes the pair of first and second inverters INV1 and INV2.

The first inverter INV1 drives the other end N30 of the coil 108 during AC oscillation. That is, an output terminal of the first inverter NV1 is electrically connected to the other end N30 of the coil 108 via the predetermined resistor R24.

The second inverter INV2 drives the one end N10 of the coil 108 during the AC oscillation. That is, an output terminal of the second inverter NV2 is electrically connected to the one end N20 of the coil 108 via the other resistor R25.

The first and second inverters INV1 and INV2 are cross-coupled to form the positive feedback circuit. That is, the output terminal of the first inverter is electrically connected to an input terminal of the second inverter INV2 via a first signal path passing through the predetermined resistor R24 and the resistor R22.

The output terminal of the second inverter is electrically connected to the input terminal of the first inverter INV2 via a second signal path passing through another resistor R25 and the resistor R23.

The first and second signal paths intersect each other, and the first and second inverters INV1 and INV2 are cross-coupled by the intersecting first and second signal paths, and thus the positive feedback circuit, in other words, specifically a flip-flop circuit is formed.

In A-1 of FIG. 9, when the switch SW of the switching unit 138 is turned on, the one end N20 of the coil 108 is forcibly connected to the ground potential. In other words, when the switch SW functioning as a forced ground fault circuit is turned on, the one end N20 of the resonance coil 108 constituting the LC resonance circuit 150 during the oscillation is forcibly grounded.

Then, the LC oscillation circuit 150 cannot maintain loop gain necessary for continuing the oscillation, and the oscillation is stopped.

Subsequently, when the potential of the wiring L12 decreases and becomes less than a threshold voltage (for example, 2.5 V) of the first inverter INV1, the power supply voltage of 5 V is output from the output terminal of the first inverter INV1, and the power supply voltage of 5 V is fed back to the input terminal of the second inverter INV2, so that the output terminal of the second inverter INV2 becomes the ground potential, and the potential of the one end N20 of the coil 108 rapidly converges to the ground potential by the positive feedback action and quickly shifts to a ground fault state.

At this time, the stable power supply voltage of 5 V is output from the first inverter INV1. Here, attention is paid to a path that electrically connects the output terminal of the first inverter INV1 to the other end N30 of the coil 108.

That is, the predetermined resistor R24 is interposed between the output terminal of the first inverter INV1 and the other end of the coil 108. Here, in the LC oscillation circuit 150 in which the oscillation is stopped, the coil 108 functions as a DC resistor R108.

Therefore, a circuit configuration in which the predetermined resistor 24 and the DC resistor R108 of the coil are connected in series between the DC voltage (5 V) output from the first inverter INV1 and the predetermined DC potential (ground potential) is implemented.

By using this circuit configuration as the resistance voltage dividing circuit, the DC voltage (DC voltage signal) Vtemp whose voltage value changes in accordance with the temperature of the coil 108 can be obtained.

Next, A-2 of FIG. 9 will be referred to. In A-2 of FIG. 9, the predetermined resistor R24 and a DC resistor R108 of the coil 108 are connected in series between the DC voltage (5 V) output from the first inverter INV1 and a predetermined DC potential (ground potential) to form a resistance voltage dividing circuit 500.

Then, a divided voltage as a DC voltage whose voltage value changes according to the temperature of the coil 108 is output from the common connection point N1 between the predetermined resistor 24 and the other end N30 of the coil 108.

When the resistance value of the predetermined resistor 24 is denoted by R24, the DC resistance value of the coil 108 is denoted by R108, and the power supply voltage is 5 V, the divided voltage (V) can be calculated by 5-{R108/(R24+R108)}.

In the example of FIG. 9, the voltage signal is amplified by the amplification unit 139. Accordingly, the DC voltage Vtemp whose voltage value changes according to the temperature of the coil 108 is obtained.

Next, A-3 of FIG. 9 will be referred to. A-3 of FIG. 9 shows a characteristic line Q1 indicating the characteristics of the DC voltage Vtemp with respect to the temperature, which is the detection output of the temperature sensor. In this example, the DC voltage Vtemp shows characteristics that the voltage increases in proportion to the temperature. However, this is merely an example, and the present invention is not limited to this example.

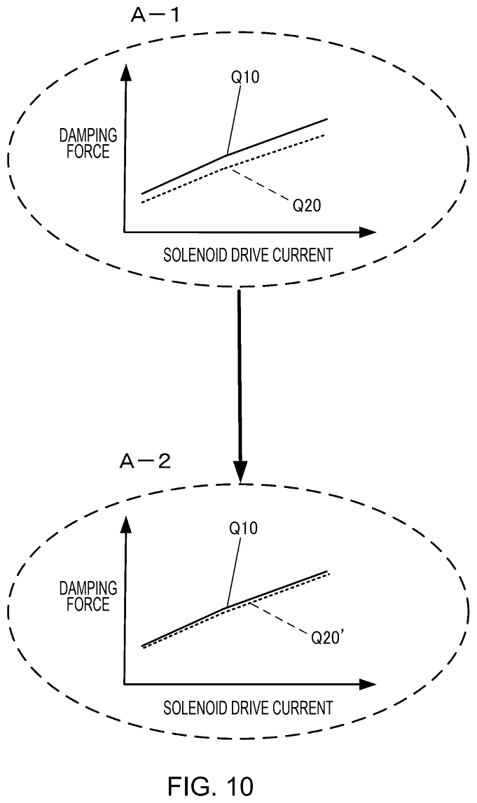

Next, FIG. 10 will be referred to. FIG. 10 is a diagram showing an effect of calibrating the solenoid drive current based on a detected temperature.

A-1 of FIG. 10 shows two characteristic lines Q10 and Q20 indicating a relation between the solenoid drive current value and the generated damping force in a case where the calibration due to temperature is not performed.

The characteristic line Q10 indicates characteristics when the temperature of the coil 108, in other words, an environmental temperature of the environment in which the coil 108 is disposed is a standard value, and the characteristic line Q20 indicates characteristics when the environmental temperature is a high temperature value.

The characteristics indicated by the characteristic line Q10 are considerably different from the characteristics indicated by the characteristic line Q20. That is, the characteristic line Q10 and the characteristic line Q20 do not match, and the degree thereof is quite large.

A-1 of FIG. 10 shows two characteristic lines Q10 and Q20′ indicating a relation between the solenoid drive current value and the generated damping force in a case where the characteristics are calibrated at a high temperature.

The characteristic line Q20′ substantially coincides with the characteristic line Q10, and a fluctuation of the damping force due to the temperature is corrected.

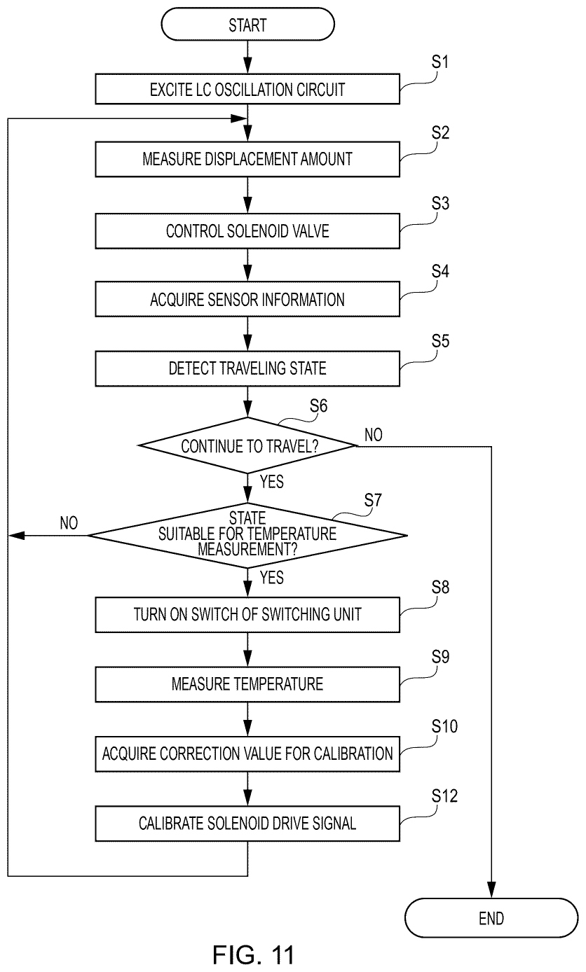

Next, FIG. 11 will be referred to. FIG. 11 is a flowchart showing an example of a control procedure of the damping force adjustable suspension system by the suspension control unit.

In step S1, for example, the LC oscillation circuit is excited when the vehicle starts traveling.

In step S2, the displacement amount, in other words, the stroke amount is measured using the stroke sensor.

In step S3, the solenoid valve is controlled. Accordingly, the damping force is variably controlled. That is, a stroke process of the suspension is detected based on the displacement amount detected in step S2.

Based on a detection result, for example, the damping force is adjusted such that the damping force is set to a first value in a compression process of the suspension and is set to a second value in an extension process.

In step S4, sensor information output from the rear suspension stroke sensor, the wheel speed sensor, the acceleration sensor, and the like, that is, detection information by various sensors is acquired.

In step S5, the traveling state of the vehicle is detected based on the acquired sensor information.

In step S6, it is determined whether the vehicle is continuing to travel. Here, the temporary stop of the vehicle is included in the continuation of traveling. For example, when the ignition switch is turned off, it is determined that the traveling is ended.

In step S6, if N, the process ends, and if Y, the process proceeds to step S7.

In step S7, it is determined whether a current state of the vehicle is suitable for the temperature measurement based on the detection result of the traveling state of the vehicle. When the determination result is N, the process returns to step S2, and when the determination result is Y, the process proceeds to step S8.

In step S7, for example, when it is determined that the vehicle is stopped, or when it is determined that the behavior of the vehicle is less than a predetermined criterion for determination and the vehicle is traveling stably, it may be determined that the vehicle is in the state suitable for the temperature measurement.

In step S8, the switch of the switching unit is turned on.

Accordingly, the one end of the coil in the LC oscillation circuit of the sensor device is connected to a predetermined potential, and the LC oscillation circuit is in a state in which a ground fault occurs. Accordingly, the function of the sensor device shifts from the function as the stroke sensor to the function as the temperature sensor.

In step S9, the temperature of the coil is measured based on the DC voltage obtained from the temperature sensor.

The temperature of the coil reflects the temperature of the hydraulic oil as the fluid, in other words, the temperature in the suspension. Therefore, the temperature of the fluid or the temperature in the suspension is substantially measured.

In step S10, the correction value for calibration corresponding to the measured temperature is acquired.

In step S11, the current value and the voltage value of the solenoid drive signal are calibrated (corrected). Thereafter, the process returns to step S2.

As described above, according to a first aspect of the present invention, there is provided a sensor device (SE) including: an LC oscillation circuit (150) including a coil (108) in which an inductance changes according to a displacement amount of an object (200) and a DC resistor changes according to a temperature, and an oscillation unit (132) including an LC resonance capacitor (134) electrically connected to the coil; and a switching unit (138) including a switch (SW) that switches whether to electrically connect one end (N20) of the coil to a predetermined DC potential, in which when the switch is off, the LC oscillation circuit is in a first state in which an AC signal (Iout) whose frequency changes according to the displacement amount of the object is output, and when the switch is on, the LC oscillation circuit stops oscillation and is in a second state in which a DC voltage (Vtemp) whose voltage value changes according to the temperature of the coil is output from a common connection point (N1) between a predetermined resistor (R24) that is a component of the oscillation unit and the other end (N30) of the coil.

According to the first aspect, by switching the operation state of the sensor device SE by turning on/off the switch SW of the switching unit 138, it is possible to implement both the stroke sensor that detects the displacement of the object and the temperature sensor that measures the temperature of the coil without adding a new configuration.

In a second aspect according to the first aspect, the oscillation unit (132) of the LC oscillation circuit (150) may include an inverter circuit (134) that excites the coil (108), the inverter circuit may include an inverter (INV1) that drives the other end of the coil, and the predetermined resistor (R24) may be electrically connected between the inverter (INV1) and the other end (N30) of the coil (108).

In the second aspect, a main part of the circuit configuration that functions as the temperature sensor when the LC oscillation circuit 150 is in the second state, that is, when the one end of the coil 108 is grounded and oscillation is temporarily stopped is exemplified.

The LC oscillation circuit 150 has a positive feedback circuit for excitation and maintaining the oscillation state, but in this aspect, the positive feedback circuit exhibits a new function and effectively functions even in a state where the oscillation is stopped.

When the switch SW of the switching unit 138 is turned on and the one end of the coil 108 is connected to the ground fault potential, for example, the ground potential, the input terminal of the inverter (first inverter) INV1 electrically connected to the other end N30 of the coil 108 among the pair of cross-coupled inverters INV1 and INV2 constituting the positive feedback circuit becomes the ground potential, and the power supply voltage of the inverter INV1 is output from the output terminal of the inverter INV1. The power supply voltage is, for example, 5 V.

This power supply voltage is applied to the other end N30 of the coil 108 via the predetermined resistor R24. Here, in a preferred example, the predetermined resistor R24 interposed between the inverter INV1 and the other end N30 of the coil 108 is not a resistor specially added in the present invention, but is provided in the normal LC oscillation circuit 150.

The predetermined resistor R24 functions as, for example, a protective resistor that suppresses direct application of the voltage of the coil 108 to the output terminal of the inverter INV1 when the LC oscillation circuit 150 is in the oscillation state, functions as a current limiting resistor that suppresses unlimited current flow when both ends of the coil 108 are short-circuited, or functions as a resistor that adjusts the loop gain of the positive feedback circuit.

In this aspect, the predetermined resistor R24 is used as a voltage dividing resistor constituting the resistance voltage dividing circuit 500.

That is, the predetermined resistor R24 and the DC resistor R108 of the coil are connected in series between the power supply potential (5 V) of the output terminal of the inverter INV1 and the ground potential that is the ground fault potential, and thus when a voltage is extracted from the common connection point N1 of the two resistors, the extracted voltage becomes an output voltage of the resistance voltage dividing circuit 500 implemented by the two resistors.

Since the DC resistor R108 of the coil 108 changes according to the temperature, the output voltage of the resistance voltage dividing circuit 500 becomes a DC voltage (DC voltage signal) that changes depending on the temperature of the coil 108.

Therefore, according to this aspect, the detection signal Vtemp of the temperature sensor can be obtained only by turning on the switch SW of the switching unit 138 and extracting the DC voltage from the common connection point between the predetermined resistor R24 and the other end N30 of the coil.

Since there are almost no components added to an LC oscillation circuit in the related art, the configuration is extremely simple and the control board is not complicated. Therefore, the control board can also be easily mounted inside the suspension whose size is reduced.

Further, in this aspect, since the stroke sensor also serves as the temperature sensor, it is not necessary to provide a temperature measurement element such as a thermistor in the hydraulic oil for the temperature measurement. Therefore, problems in the related art that there is no empty space in the suspension and the thermistor or the like cannot be disposed are solved.

In a third aspect according to the first aspect, the oscillation unit (132) of the LC oscillation circuit (150) may include an inverter circuit (134) that excites the coil (108), the inverter circuit may include a pair of first and second inverters (INV1 and INV2), an output terminal of the first inverter (INV1) may be electrically connected to the other end (N30) of the coil via the predetermined resistor (R24), an output terminal of the second inverter (INV2) may be electrically connected to the one end (N20) of the coil via another resistor (R25), by electrically connecting the output terminal of the first inverter (INV1) and an input terminal of the second inverter (INV2) to each other, and electrically connecting the output terminal of the second inverter (INV2) and an input terminal of the first inverter (INV1) to each other, the first and second inverters (INV1, INV2) may be cross-coupled to form a positive feedback circuit, and when the LC oscillation circuit 150 is in the second state, the predetermined resistor (R24) and the DC resistor (R108) of the coil may be connected in series between the DC potential of the output terminal of the first inverter (INV1) and the predetermined DC potential to form a resistance voltage dividing circuit (400), and a divided voltage as a DC voltage (Vtemp) whose voltage value changes according to the temperature of the coil may be output from the common connection point (N1) between the predetermined resistor (R24) and the other end (N30) of the coil.

In the third aspect, it is clarified that the inverter circuit includes the pair of cross-coupled first and second inverters (INV1 and INV2).

The operation of the first inverter is as described in the second aspect.

In this aspect, when the power supply voltage (5 V) of the inverter INV1 is output from the output terminal of the first inverter INV1, the power supply voltage is applied to the input terminal of the cross-coupled second inverter INV2, and the output of the second inverter INV2 rapidly changes to the ground potential.

That is, when the switch SW of the switching unit 138 is turned on and the one end of the coil 108 is grounded, the potential of the one end of the coil 108 decreases, and at this time, the output terminal of the second inverter INV2 rapidly becomes the ground potential by the action of the positive feedback circuit, and thus the one end N20 of the coil 108 rapidly converges to the ground potential. Therefore, the time until the grounding (ground fault) of the one end N20 of the coil 108 is completed is shortened.

That is, in this aspect, the positive feedback circuit achieves a new first effect of speeding up the convergence of the one end N20 of the coil 108 to the ground potential (ground fault potential) and realizing grounding (ground fault) at a predetermined timing.

Voltage levels of the outputs of the first and second inverters INV1 and INV2 are stabilized by the positive feedback action of the positive feedback circuit.

That is, even if noise is superimposed on the circuit, the output voltages of the first and second inverters INV1 and INV2 do not change unless the noise has a voltage level exceeding the threshold of the first and second inverters INV1 and INV2. Therefore, the power supply voltage output from the first inverter INV1 is a stable power supply voltage that is resistant to noise.

That is, in this aspect, the positive feedback circuit has a new second effect of stabilizing the power supply voltage supplied to the resistance voltage dividing circuit 500 at the time of temperature measurement.

As described above, according to this aspect, the oscillation of the LC oscillation circuit 150 can be quickly stopped at the predetermined timing and the stroke sensor can be changed to the temperature sensor. Further, by stabilizing the power supply voltage by the positive feedback circuit, it is possible to detect the temperature with high accuracy.

In a fourth aspect according to any one of the first to third aspects, there may be provided an amplification unit (139) configured to amplify a DC voltage that is output from the common connection point between the predetermined resistor and the other end of the coil and whose voltage value changes according to the temperature of the coil.

According to the fourth aspect, the DC voltage whose voltage value changes depending on the temperature of the coil can be amplified by the amplification unit 139. This amplification makes it easier for the CPU 320 as the control unit to detect the change in the voltage value due to the temperature change, and the detection accuracy is improved.

In a fifth aspect according to the fourth aspect, at least one of the amplification unit (139) and the switching unit (138) may be provided integrally with a coil member (106) as an electric component including the coil.

In this aspect, since at least one of the switching unit 138 and the amplification unit 139 is provided integrally with the coil member, it is not necessary to mount the switching unit or the amplification unit on the control board. Therefore, for example, even if the size and weight of the suspension are reduced and the area occupied by the circuit on the control board is further reduced, since the installation space for the switching unit or the amplification unit is unnecessary, it is possible to cope with this.

Further, according to this aspect, since the switching unit 138 can be disposed near the one end N20 of the coil 108, when the switch SW of the switching unit 138 is turned on, the one end N20 of the coil 108 can be connected to the predetermined potential, for example, the ground potential with low impedance, and thus it is possible to shorten the time required to shift the LC oscillation circuit 150 in the oscillation state to the state in which the oscillation is stopped.

Further, according to this aspect, the amplification unit 139 can be disposed near the one end N20 of the coil 108, and thus the DC voltage reflecting the temperature of the coil 108 can be amplified in the state in which the damping is small or the noise is small. Therefore, the detection accuracy is improved.

In a sixth aspect according to the first to fifth aspects, the switch (SW) in the switching unit (138) may include at least one selected from a bipolar transistor, a field-effect transistor, a photocoupler, and a relay.

In this aspect, the switch SW of the switching unit 138 may be implemented by, as the switch element, the bipolar transistor, the field-effect transistor (FET), the photocoupler, or the relay, or may be implemented by appropriately combining the switch elements.

That is, the switching unit 138 of this aspect has the simple configuration and the small size, and thus can be easily mounted on the control boards 140, 350, and 350′.

In a seventh aspect of the present invention, there is provided a damping force adjustable suspension system (400) including: a suspension (19) including a tubular first member (100) and a tubular second member (200) provided to be movable relative to the first member in an axial direction of the first member, and configured to accommodate a fluid therein; an electronically controlled damping force adjustable unit (130) having a solenoid (133), configured to variably control a resistance of the fluid moving according to a relative positional relation between the first member and the second member by a drive current or a drive voltage of the solenoid, and integrally attached to the suspension; the sensor device (SE) according to any one of the first to sixth aspects disposed in the suspension and configured to use either the first member or the second member as the object; and a suspension control unit (300) having a function of controlling on/off of the switch in the switching unit and a function of controlling the electronically controlled damping force adjustable unit, in which the suspension control unit (300) is provided in the suspension (19) or integrally attached to the suspension (19).

According to this aspect, the electronically controlled damping force adjustable unit 130, the sensor device SE, and the suspension control unit 300 are aggregated in the suspension 19 having a mechanical structure.

That is, by the “design of mechanical and electrical integration” in which the “mechanical configuration” and the “electrical configuration” are integrated, all the components related to the correction of the temperature-dependent damping force characteristics can be disposed near the fluid (hydraulic oil) as a heat source, and thus the temperature environment of each component is made common.

That is, it is possible to satisfy the condition that the temperature environment is made common as a precondition necessary for correcting the temperature-dependent damping force characteristics.

Further, regarding the temperature measurement of the fluid (hydraulic oil), by using the sensor device SE that also serves as the temperature sensor described above, a temperature measurement element such as the thermistor and a wiring for the temperature measurement become unnecessary, and the problem in the related art that there is no space for disposing the thermistor or the like in the suspension 19 is also solved.

The control board (circuit board) 140 (see FIG. 3) may be disposed in the suspension 19, or may be integrally attached to, for example, an outer surface of the member constituting the suspension 19.

As described above, according to this aspect, it is possible to correct the temperature-dependent damping force characteristics, which has been difficult in the related art, by aggregating the control board on the suspension by the design of mechanical and electrical integration and by utilizing the sensor device serving as both the stroke sensor and the temperature sensor.

In an eighth aspect according to the seventh aspect, the suspension control unit (300) may include a displacement measurement unit (319) configured to measure a displacement of the object based on an AC signal (Iout) that is output from the sensor device (SE) and whose frequency changes according to a displacement amount of the object, a temperature measurement unit (322) configured to measure a temperature of the coil based on a DC voltage (Vtemp) that is output from the sensor device and whose voltage value changes according to the temperature of the coil, a calibration unit (324) configured to change a drive current value or a drive voltage value of the solenoid according to a temperature measurement result, a solenoid drive unit (330) configured to drive the solenoid in the electronically controlled damping force adjustable unit with the calibrated drive current or drive voltage of the solenoid, and a switching control unit (334) configured to control on/off of the switch in the switching unit.

According to the eighth aspect, it is possible to implement the highly functional suspension control unit 300 having a function of measuring the displacement amount, a function of measuring the temperature, a function of correcting the drive signal of the solenoid of the electronically controlled damping force adjustable unit according to the temperature, and the like

The suspension control unit 300 may be mounted on, for example, the electronic control unit (ECU) board for suspension.

In a ninth aspect according to the eighth aspect, the suspension control unit (300) may further include a traveling state detection unit (321) configured to detect a traveling state of a vehicle (1) on which the damping force adjustable suspension system (400) is mounted.

In the ninth aspect, the traveling state detection unit 321 detects the traveling state of the vehicle 1 on which the damping force adjustable suspension system 400 is mounted.

When the oscillation of the LC oscillation circuit 150 is stopped for the temperature measurement while the vehicle 1 is traveling, the output of the stroke sensor may not be obtained, and the cycle of a compression and expansion stroke of the suspension cannot be known. Therefore, when the temperature measurement is performed in a situation in which a operation state of the vehicle 1 significantly fluctuates, the damping force may not be appropriately controlled.

Therefore, the traveling state detection unit 321 collects sensor information on the traveling of the vehicle 1 obtained from, for example, the various sensors 302, and detects the traveling state (operation state) of the vehicle 1 based on the information.

For example, the temperature measurement is performed when it is determined that the vehicle 1 is in the traveling state suitable for the temperature measurement. Accordingly, the above problem is solved.

In a tenth aspect according to the ninth aspect, the switching control unit (334) may turn on the switch (SW) of the switching unit (138) when it is determined that the vehicle is stopped or when it is determined that behavior of the vehicle changes little and the vehicle is in a stable traveling state as a result of the detection of the traveling state of the vehicle by the traveling state detection unit (321).

The tenth aspect exemplifies the case where it is determined that the vehicle 1 is in the state suitable for the temperature measurement.

For example, this corresponds to the case where the vehicle is stopped or the case where the behavior of the vehicle changes little and the vehicle is in the stable traveling state. Specifically, the behavior of the vehicle may include behavior such as vehicle speed fluctuations and lateral swaying when the vehicle is traveling linearly, or rotation behavior indicating that the vehicle is rotating (turning).

For example, when the vehicle is turning around a curve of a traveling road, the traveling direction is constantly changing, the vehicle speed may also decelerate or accelerate rapidly, and thus it is considered that the vehicle does not correspond to a state suitable for the temperature measurement in many cases.

When the traveling of the vehicle is stopped, there is no particular problem even if the detection signal of the stroke sensor may not be obtained.

When the vehicle is traveling stably, the suspension is considered to repeat the compression and expansion at the constant cycle. Therefore, even if the detection signal of the stroke sensor may not be obtained for a while, it is considered that there will be no particular problem during that period by, for example, maintaining the cycle detected immediately before and adjusting the damping force.

In the period for temperature measurement, the temperature measurement is quickly performed, and after the temperature measurement is completed, the stroke sensor is operated again to detect the compression and expansion process of the suspension, and the damping force is adjusted at an appropriate timing.

At this time, by correcting the drive signal of the solenoid in accordance with the detected temperature, it is possible to realize the damping force characteristics similar to those at the standard temperature, even at a high temperature, for example. Therefore, the shock absorbing performance in the motorcycle and the like can be improved.

As described above, according to the present invention, it is possible to provide the sensor device capable of measuring the temperature of, for example, the fluid without newly adding a temperature sensor.

Further, according to the present invention, it is possible to provide the damping force adjustable suspension system capable of correcting the damping force according to a temperature.

In the above description, the motorcycle has been described as an example, but the planar coil array of the present invention is also applicable to a three-wheeled vehicle, a four-wheeled vehicle, and the like, is also applicable to an electric automobile that is currently being developed, and the type of the vehicle is not limited.

The present invention is not limited to the examples as long as operations and effects of the invention are exhibited.

### INDUSTRIAL APPLICABILITY

The present invention is suitable as a sensor device and a damping force adjustable suspension system that can be used for various applications.

### REFERENCE SIGNS LIST

1 vehicle (motorcycle)
2 front wheel
3 rear wheel
11 vehicle body frame
12 handlebar
13 engine
15 vehicle main body
19 front fork (front suspension, suspension)
22 rear suspension
51 pipe
53 tube
61 reservoir
100 outer tube (first member)
102 piston
104 rod
105, 107, 205, 207 check valve
106 coil member
108 coil (resonance coil)
110 rod guide
112 conductor tube (conductor member, plate-shaped conductor member, rod-shaped conductor member)
120 stroke sensor
130 electronically controlled damping force adjustable unit (damping force adjustable unit, damping force generation unit, damping force adjustable mechanism, solenoid valve)
132 oscillation unit
133 solenoid (control solenoid)
134 capacitor (resonance capacitor)
135 waveform shaping unit
136 inverter (inverter circuit, amplification circuit, excitation amplification circuit)
137 frequency dividing unit
138 switching unit
139 amplification unit
140 control board (circuit board)
142 interface unit
144 interface circuit
150 LC oscillation circuit
200 inner tube (second member)
205 check valve
210 suspension arm
300 suspension control unit
302 various sensors
303 rear suspension stroke sensor
305 wheel speed sensor
307 acceleration sensor
310 input interface
311 buffer
319 displacement measurement unit
320 CPU (processor, control unit)
330 solenoid drive unit
334 switching control unit
340 output interface
350, 350′ control board (ECU board)
400 damping force adjustable suspension system
SE sensor device
SW switch
Iout AC signal as current signal (AC signal, oscillation signal, AC signal whose frequency changes according to displacement amount of object)
Vtemp DC voltage as temperature detection signal (DC voltage, DC voltage whose voltage value changes according to temperature of coil, DC voltage signal)
INV1 first inverter (inverter element, inverter)
INV2 second inverter (inverter element, inverter)
R24 predetermined resistor (voltage dividing resistor constituting resistance voltage dividing circuit)
R25 another resistor
L11, L12, L20 wiring
CHM1 first oil chamber
CHM2 second oil chamber
D fitting length
RD current-voltage conversion resistor
OP operational amplifier
Vbias bias voltage (DC bias voltage)
N1 common connection point between predetermined resistor and other end of coil
N20 one end of coil
N30 other end of coil
I-SLD solenoid drive current signal
SC temperature measurement start notification signal
TC switching control signal

What is claimed is:

1. A sensor device comprising:
an LC oscillation circuit including a coil in which an inductance changes according to a displacement amount of an object and a DC resistor changes according to a temperature, and an oscillation unit including an LC resonance capacitor electrically connected to the coil; and
a switching unit including a switch that switches whether to electrically connect one end of the coil to a predetermined DC potential, wherein
when the switch is off, the LC oscillation circuit is in a first state in which an AC signal whose frequency changes according to the displacement amount of the object is output, and
when the switch is on, the LC oscillation circuit stops oscillation and is in a second state in which a DC voltage whose voltage value changes according to the temperature of the coil is output from a common connection point between a predetermined resistor that is a component of the oscillation unit and other end of the coil.

2. The sensor device according to claim 1, wherein
the oscillation unit of the LC oscillation circuit includes an inverter circuit that excites the coil,
the inverter circuit includes an inverter that drives the other end of the coil, and
the predetermined resistor is electrically connected between the inverter and the other end of the coil.

3. The sensor device according to claim 1, wherein
the oscillation unit of the LC oscillation circuit includes an inverter circuit that excites the coil,
the inverter circuit includes a pair of first and second inverters,
an output terminal of the first inverter is electrically connected to the other end of the coil via the predetermined resistor,
an output terminal of the second inverter is electrically connected to the one end of the coil via another resistor,
by electrically connecting the output terminal of the first inverter and an input terminal of the second inverter to each other, and electrically connecting the output terminal of the second inverter and an input terminal of the first inverter to each other, the first and second inverters are cross-coupled to form a positive feedback circuit, and
when the LC oscillation circuit is in the second state,
the predetermined resistor and the DC resistor of the coil are connected in series between a DC potential of the output terminal of the first inverter and the predetermined DC potential to form a resistance voltage dividing circuit, and
a divided voltage as a DC voltage whose voltage value changes according to the temperature of the coil is output from the common connection point between the predetermined resistor and the other end of the coil.

4. The sensor device according to claim 1, further comprising:
an amplification unit configured to amplify a DC voltage that is output from the common connection point between the predetermined resistor and the other end of the coil and whose voltage value changes according to the temperature of the coil.

5. The sensor device according to claim 4, wherein
at least one of the amplification unit and the switching unit is provided integrally with a coil member as an electric component including the coil.

6. The sensor device according to claim 1, wherein
the switch in the switching unit includes at least one selected from a bipolar transistor, a field-effect transistor, a photocoupler, and a relay.

7. A damping force adjustable suspension system comprising:
a suspension including a tubular first member and a tubular second member provided to be movable relative to the first member in an axial direction of the first member, and configured to accommodate a fluid in the suspension;
an electronically controlled damping force adjustable unit having a solenoid, configured to variably control a resistance of the fluid moving according to a relative positional relation between the first member and the second member by a drive current or a drive voltage of the solenoid, and integrally attached to the suspension;
the sensor device according to claim 1 disposed in the suspension and configured to use either the first member or the second member as the object; and
a suspension control unit having a function of controlling on/off of the switch in the switching unit and a function of controlling the electronically controlled damping force adjustable unit, wherein
the suspension control unit is provided in the suspension or integrally attached to the suspension.

8. The damping force adjustable suspension system according to claim 7, wherein
the suspension control unit includes
a displacement measurement unit configured to measure a displacement of the object based on an AC signal that is output from the sensor device and whose frequency changes according to a displacement amount of the object,
a temperature measurement unit configured to measure a temperature of the coil based on a DC voltage that is output from the sensor device and whose voltage value changes according to the temperature of the coil,
a calibration unit configured to change a drive current value or a drive voltage value of the solenoid according to a temperature measurement result,
a solenoid drive unit configured to drive the solenoid in the electronically controlled damping force adjustable unit with the calibrated drive current or drive voltage of the solenoid, and
a switching control unit configured to control on/off of the switch in the switching unit.

9. The damping force adjustable suspension system according to claim 8, wherein
the suspension control unit further comprises
a traveling state detection unit configured to detect a traveling state of a vehicle on which the damping force adjustable suspension system is mounted.

10. The damping force adjustable suspension system according to claim 9, wherein
as a result of the detection of the traveling state of the vehicle by the traveling state detection unit,
when it is determined that the vehicle is stopped, or
when it is determined that behavior of the vehicle changes little and the vehicle is in a stable traveling state,
the switching control unit turns on the switch of the switching unit.
